(19) United States
(12) Patent Application Publication
(10) Pub. No.: US 2005/0236218 A1
(43) Pub. Date: Oct. 27, 2005

(54) Rack and pinion steering system

(76) Inventors: Jurgen Osterlanger, Emskirchen (DE); Alexander Zernickel, Herzogenaurach (DE); Stefan Willared, Erlangen (DE)

Correspondence Address: OSTROLENK FABER GERB & SOFFEN, 1180 AVENUE OF THE AMERICAS, NEW YORK, NY, 100368403, US

(21) Appl. No.: 11/082,538

(22) Filed: Mar. 17, 2005

(30) Foreign Application Priority Data
Mar. 18, 2004 (DE) 10 2004 013 167.8

(51) Int. Cl. B62D 5/06; B62D 5/04

(52) U.S. Cl. 180/428; 180/444

(57) ABSTRACT

A rack and pinion steering system for a motor vehicle including a supporting spindle receiving a guide roller, the roller is held at its two ends in a thrust piece via a needle bush at each end. The bush has a closed bottom which bears against an end face of the supporting spindle under prestress. The thrust piece is spring urged against the rack and the rack is spring engaged by the pinion via the urging of the thrust piece.

### AREA OF APPLICATION OF THE INVENTION

The invention relates to a rack and pinion steering system for a motor vehicle, including a steering housing, in which a rack is mounted longitudinally displaceably, and also including a pinion meshing with the rack. A thrust piece is arranged on a side of the rack which is opposite an engagement side of the thrust piece with the pinion. The thrust piece is prestressed against the rack with the aid of a spring. The thrust piece has in its interior a rotatable guide roller adapted to the contour of the rack. The roller has a supporting surface, against which the rack bears with a corresponding supporting surface.

### BACKGROUND OF THE INVENTION

Such rack and pinion steering systems have long been known from the prior art. In these steering systems, the rack is guided displaceably in the longitudinal direction in a steering housing. A pinion mounted rotatably in the steering housing engages in the toothing of the rack. Rotation of the steering column connected in a rotationally fixed manner to the pinion brings about lateral displacement of the rack, which in turn leads, via tie rods and steering knuckles, to pivoting of the steered wheels of the motor vehicle. The engagement of the pinion in the rack is kept free from play by a thrust piece, which bears against the rack on the side of the rack opposite the pinion, and presses the rack against the pinion under prestress. In this connection, the thrust piece on the one hand should be capable of transmitting the necessary pressing force and on the other hand should provide a bearing surface which does not give rise to any appreciable frictional forces or any appreciable wear when the rack is displaced on the thrust piece. If the steering force applied by the hand of the driver via the pinion is then intensified by a ball screw drive, the rack will have a tendency, owing to the torque transmission, to rotate in the peripheral direction over its axial length. Efforts are made to prevent this by arranging the supporting surfaces of guide roller and rack in relation to one another in such a way that they oppose rotation of the rack.

Such a rack and pinion steering system is previously known from DE 82 03 943 U. As FIG. 5 of this prior publication shows, the rack has two supporting surfaces which are inclined symmetrically in relation to the toothing plane. The rack and pinion steering system also includes a guide roller, which is arranged in a thrust piece and likewise has two supporting surfaces. The supporting surfaces of the rack are produced by removing material by metal-cutting from the originally round rack. The supporting surfaces of the guide roller are formed by two outer rings of a ball bearing, which are arranged in the thrust piece and the lateral surfaces of which, which form the supporting surfaces, are likewise arranged in symmetrically inclined fashion in relation to the toothing plane. It is obvious that such positioning of the supporting surfaces of rack and guide roller will prevent rotation of the rack in the peripheral direction.

The complicated design of the supporting surfaces of rack and guide roller is a disadvantage of such a rack and pinion steering system. On the one hand, the machining of the rack is complicated and thus expensive because a considerable amount of material is to be removed. On the other hand, the thrust piece has a very complicated construction and is thus likewise costly. Two ball bearings each have to be accommodated via a bolt in the thrust piece, which makes great demands on assembly and moreover also requires additional construction space. It is also a disadvantage that it is not possible with such a generically designed thrust piece, the guide roller of which is very easy-running, to set a defined friction. This is important, however, because, with too low a moment of friction, the longitudinal oscillations of the rack initiated by wheel wobble are continued into the steering wheel, which has a negative effect on steering comfort.

### SUMMARY OF THE INVENTION

Starting from the disadvantages of the known prior art, it is therefore an object of the invention to provide a considerably simplified rack and pinion steering system which can be produced more simply and can safely take up torques and radial and axial forces with a high load-carrying capacity. It is also an object of the invention that undesirable oscillations are damped.

According to the invention, this object is achieved by holding the two ends of supporting spindle receiving the guide roller in the thrust piece via a needle bush at each end. The closed bottom of the needle bush bears against an end face of the supporting spindle under prestress. The bearing of the bottom of the needle bush against the end face of the supporting bolt sets a defined moment of friction, which makes rotation of the guide roller more difficult. The longitudinal oscillations of the rack initiated by wheel wobble of the motor vehicle are consequently at least damped, if not even eliminated, by the somewhat more sluggish guide roller.

The bottom of the needle bush can be shaped in different ways. For example, it can be of dome-shaped design, be provided with an inwardly facing abutment face or have a waffle-shaped structure.

It is also possible to manufacture the needle bush from a thin-walled metal sheet and the bottom has spring-elastic properties.

According to another feature, an abutment disk is arranged between the bottom of the needle bush and the end face of the supporting spindle.

According to yet another feature, the abutment disk can be made from a synthetic material or from Permaglide. Permaglide is to be understood as a sliding material which consists of a steel back onto which a bronze layer is sintered, a mixture consisting of polytetrafluoroethylene (PTFE) and lead being rolled into the pores of the bronze layer as the sliding layer. According to another feature, this abutment disk can have a waffle-shaped structure in the direction of the supporting spindle, which is favorable in particular for taking up lubricant.

According to another feature, an axial needle bearing is arranged between the bottom of the needle sleeve and the end face of the supporting bolt. The additional arrangement of the axial bearing has the advantage in comparison with sliding friction that, in addition to minimizing wear, smaller fluctuations of the moment of friction also occur. Accordingly, a stick/slip-free bearing is produced.

According to still another feature, axes of rotation of bearing needles arranged in pockets of a cage occupy a position deviating at an angle from a radius of the rolling thrust bearing passing through a center point of the bearing needles. More simply, the pockets of the rolling thrust bearing are designed as slant pockets. This has the advantage that, in comparison with an axial needle bearing of normal design, the moment of friction is increased again.

According to yet another feature, a lower guide part of the thrust piece has an enlarged diameter in relation to an upper part of the thrust piece. This ensures that the thrust piece is guided accurately with its lower part in a receiving bore.

A number of apertures spaced from one another and extending in the axial direction are provided in the upper part of the thrust piece. These apertures provide the thrust piece with a spring action in its upper part, so that the needle sleeve can bear against the end side of the supporting spindle with prestress.

The supporting surfaces of rack and guide roller are arranged in relation to one another such that rotation of the rack in the peripheral direction is prevented. Prevention of such rotation of the rack is important especially when the steering force is intensified by an additional device, for example by a ball screw drive. This is because in this case, the rack has a tendency to rotate in the peripheral direction. However, this rotation is prevented by the design of the supporting surfaces in relation to one another.

According to a further feature, the supporting surface is formed as at least one recess located within the rack. In the context of the invention, this means that, in the lower part of the rack, that is, in the region of the guide roller, the circumference or periphery of the rack is interrupted only very slightly. This has the advantage that the recess serving as the supporting surface can be machined into the rack by a simple metal-cutting process, for example by milling. The round cross-sectional profile of the rack is essentially maintained as well. It is therefore no longer necessary to remove vast amounts of material by metal-cutting in accordance with the prior art in order to produce the supporting surface. This recess can be of either semicircular or V-shaped design.

The guide roller is designed in two parts, and guide roller and supporting spindle are designed in one piece.

The invention is explained in greater detail with reference to illustrative embodiments below.

Other features and advantages of the present invention will become apparent from the following description of the invention which refers to the accompanying drawings.

### BRIEF DESCRIPTION OF THE DRAWINGS

FIG. 1 shows a side view of a thrust piece with a rack, partly in section;

FIG. 2 shows a perspective illustration of a shell of a thrust piece;

FIG. 3 shows a side view of the shell of the thrust piece according to FIG. 2;

FIG. 4 shows a side view of a thrust piece with a rack;

FIG. 5 shows a top view of a rolling thrust bearing, and

FIG. 6 shows a longitudinal section through a thrust piece with a rack according to the prior art.

### DETAILED DESCRIPTION OF THE DRAWINGS

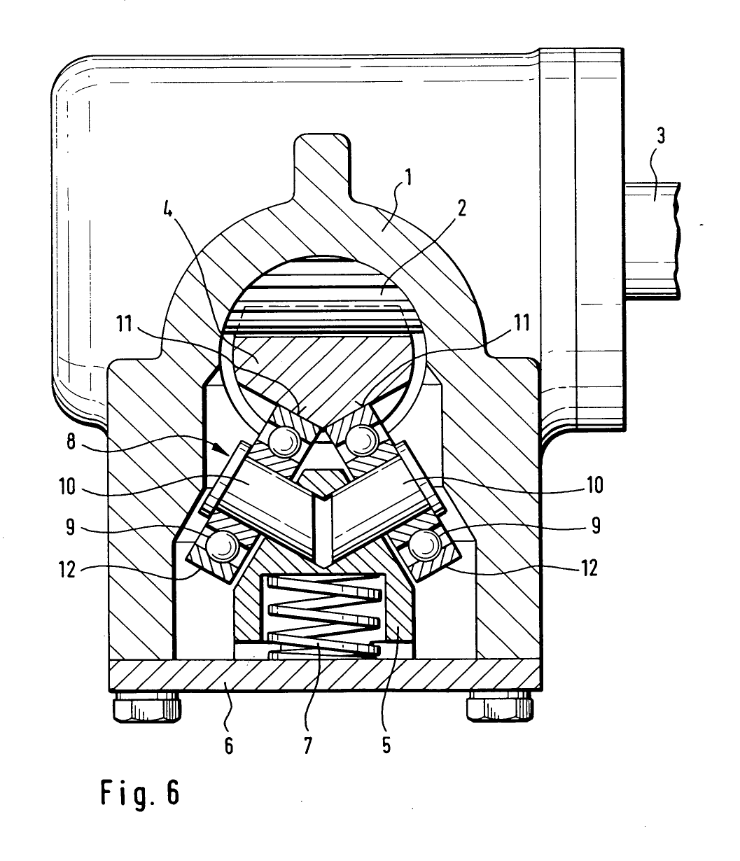

To illustrate the overall context, reference will first be made to the prior art according to FIG. 6. This shows a housing 1, in which a pinion 2, which joins a steering shaft 3, is mounted. The toothing of a rack 4, which extends transversely to the pinion 2, engages in the toothing of the pinion 2. A thrust piece 5, which essentially supports the force transmitted from the pinion 2 to the rack 4, is arranged on the side opposite the engagement side of the pinion 2 with the rack 4. The thrust piece 5 is accommodated in a receiving bore (not designated) of the housing 1. It is prestressed in the direction of the rack 4 by a spring 7 arranged between the thrust piece 5 and a cover connected rigidly to the housing 1.

A guide roller 8, comprised of two rolling bearings 9 designed as deep-groove ball bearings each held on a supporting spindle 10, is accommodated in the thrust piece 5. The supporting spindles 10 and thus the rolling bearings 9 are arranged at a given angle to the toothing plane, so that the inclined bearing outer rings of the rolling bearings 9 bear with their supporting surfaces 12 against the supporting surfaces 11 of the rack 4, so that the latter cannot move in the peripheral direction in the event of a torque being applied, for example by a ball screw drive.

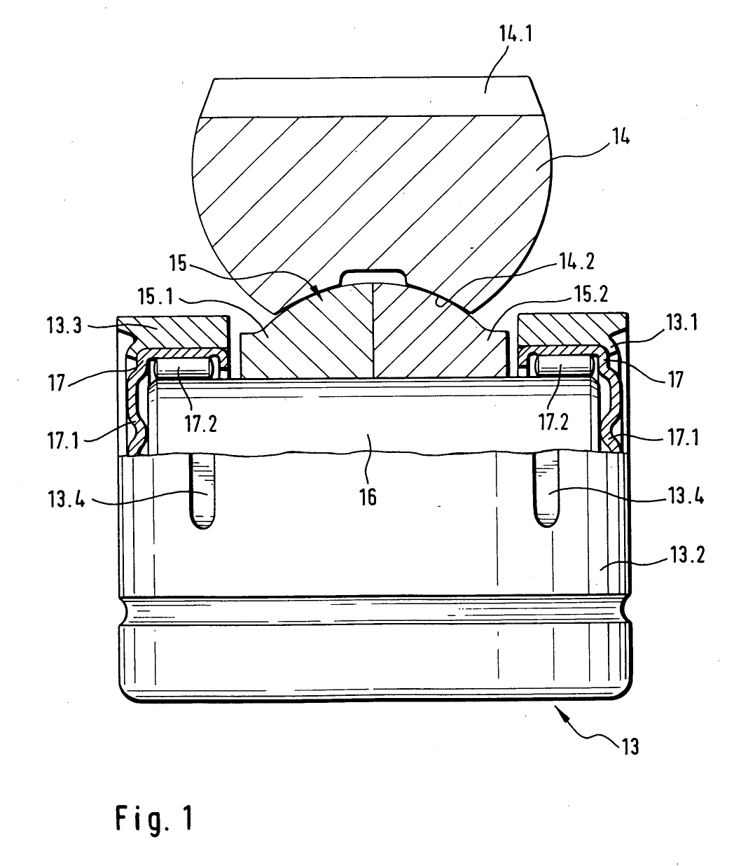

FIG. 1 shows an arrangement of a thrust piece 13 according to the invention and a rack 14, the rack 14 having the toothing 14.1, in which a pinion (not illustrated) engages, on its side facing away from the thrust piece 13. On its side opposite the toothing 14.1, the rack 14 has a recess 14.2, which is designed in a curved shape or as a Gothic profile with two contact points. A guide roller 15, comprised of the two parts 15.1, 15.2 and having a contour adapted to the recess 14.2, engages in this recess 14.2 of the rack 14. It can be seen that rotation of the rack 14 in the peripheral direction is prevented in this way. A supporting spindle 16, to which the guide roller 15 is firmly connected, for example by a press fit or a form fit, extends through the roller. The two opposite ends of the supporting spindle 16 are each received by a needle bush 17, the bottom 17.1 of which has in its center a projection (not designated further) which bears against the end face of the supporting spindle 16 under prestress. The needle bush 17 includes the bearing needles 17.2, the raceways of which are formed by on the one hand the needle bush 17 itself and on the other hand a part of the lateral surface of the supporting spindle 16. The needle bush 17 is held in the thrust piece 13 by caulking 13.1. If the rack 14 is now displaced in its longitudinal direction via a pinion (not illustrated), it rolls with its recess 14.2 on the guide roller 15. This then rotates in the peripheral direction on the supporting spindle 16, forces in the radial direction being taken up in rolling friction by the bearing needles 17.2, while forces in the axial direction are taken up slidingly by means of the bottom 17.1 of the needle bush 17.

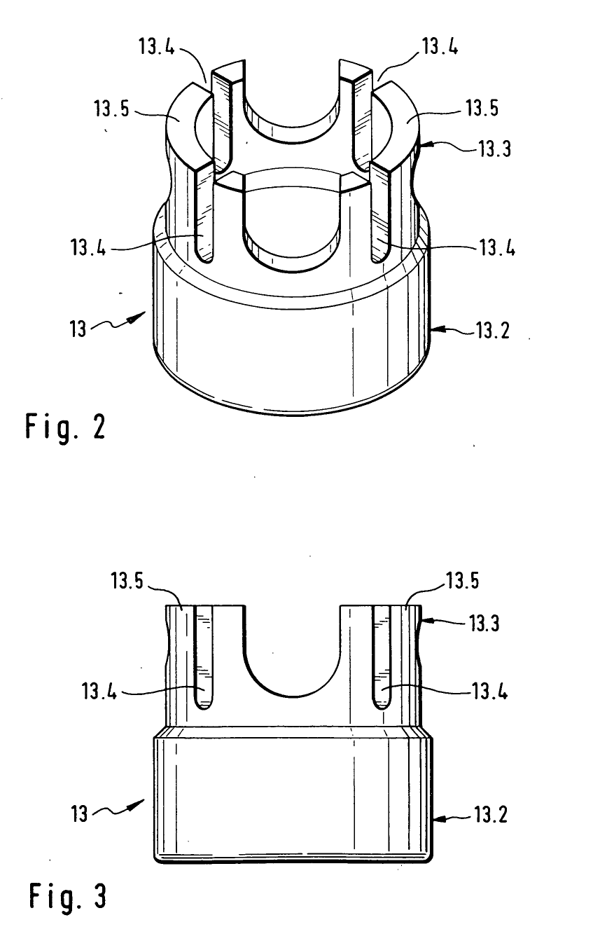

As can be seen from FIGS. 2 and 3, the thrust piece 13 has a stepped shape in such a way that a lower part 13.2 serving for guidance has a larger diameter in relation to an upper part 13.3. The upper part 13.3 of the thrust piece 13 is provided with a number of apertures 13.4 which are spaced from one another in the peripheral direction and extend in the axial direction, so that two opposite part regions 13.5 are formed, which have resilient properties. These part regions 13.5 ensure that the two needle bushes 17 are moved toward one another and in this way the prestress is brought about with the aid of the needle bush bottom 17.1.

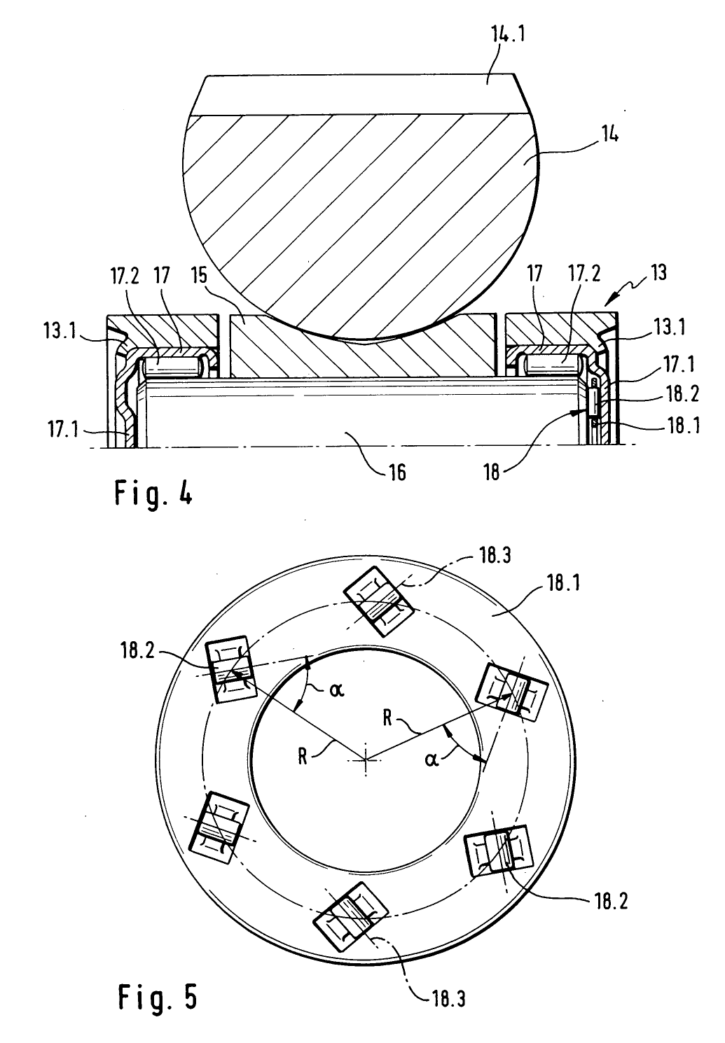

The difference between the arrangements shown in the right-hand part of FIG. 4 and in FIG. 1 is that in FIG. 4 the rack 14 is not secured against rotation in the peripheral direction. The supporting surfaces of the rack 14 and of the guide roller 15 are selected in such a way that the rack 14 can rotate within the guide roller 15. A further difference is that an axial needle bearing 18 is arranged between the bottom 17.1 of the needle bush 17 and the end face of the supporting spindle 16. This bearing comprises bearing needles 18.2, which are guided in a cage 18.1, so that rolling friction is brought about between the end face of the supporting spindle 16 and the prestressed bush bottom 17.1. As can be seen in FIG. 5, the pockets of the axial needle bearing 18 can be designed as slant pockets, and the axes of rotation 18.3 of bearing needles 18.2 arranged in pockets of the cage 18.1 occupy a position deviating at an angle α from the radius R of the rolling thrust bearing 18 passing through a center point of the bearing needles 18.2.

The figures referred to show a unit comprised of thrust piece 13 and rack 14, which is distinguished by the following advantages:
cost-effective production and assembly;
great smoothness of running;
safe take-up of axial and radial forces and torques acting on it;
great load-carrying capacity;
adjustable prestress for oscillation damping.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A rack and pinion steering system for a motor vehicle, comprising:
a steering housing;
a rack mounted longitudinally displaceably in the housing; the rack having a pinion engagement side;
a pinion meshing with the pinion engagement side of the rack;
a thrust piece arranged on a side of the rack opposite the pinion engagement side, a spring prestressing the thrust piece against the rack, the thrust piece having an interior;
a rotatable guide roller in the interior of the thrust piece, the guide roller having a contour adapted to a contour of the rack;
the guide roller having a first supporting surface, the rack having a second supporting surface which bears against the first supporting surface,
a supporting spindle receiving the guide roller, the spindle having two ends held in the thrust piece and each spindle end is supported in a needle bush, the spindle ends having end faces, the needle bush has a closed bottom which bears against the respective end face of the supporting spindle under prestress.

2. The rack and pinion steering system as claimed in claim 1, wherein the bottom of the needle bush is of dome-shaped design, and has an inwardly facing abutment face or has a waffle-shaped structure.

3. The rack and pinion steering system as claimed in claim 1, wherein the needle bush is comprised of a thin-walled metal sheet and the bottom thereof has spring-elastic properties.

4. The rack and pinion steering system as claimed in claim 1, further comprising an abutment disk arranged between the bottom of the needle bush and the end face of the supporting spindle.

5. The rack and pinion steering system as claimed in claim 4, wherein the abutment disk is comprised of a synthetic material or from Permaglide.

6. The rack and pinion steering system as claimed in claim 4, wherein the abutment disk has a waffle-shaped structure in the direction of the supporting spindle.

7. The rack and pinion steering system as claimed in claim 1, further comprising an axial needle bearing arranged between the bottom of the needle bush and the end face of the supporting spindle.

8. The rack and pinion steering system as claimed in claim 7, wherein the axial needle bearing comprises a cage having pockets, a plurality of bearing needles in the cage pockets and the neeldes are supported such that respective axes of rotation of the bearing needles arranged in the pockets of the cage occupy a position deviating at an angle α from a radius R of the axial needle bearing passing through a center point of the bearing needles.

9. The rack and pinion steering system as claimed in claim 1, wherein the thrust piece further comprises an upper guide part, and a lower guide part having an enlarged diameter in relation to a diameter of the upper part of the thrust piece.

10. The rack and pinion steering system as claimed in claim 9, further comprising a plurality of apertures located in the upper part of the thrust piece spaced from one another and extending in the axial direction.

11. The rack and pinion steering system as claimed in claim 1, wherein the first and second supporting surfaces of the rack and guide roller are arranged in relation to one another for preventing rotation of the rack in the peripheral direction.

12. The rack and pinion steering system as claimed in claim 11, wherein the supporting surface comprises at least one recess located within the rack.

13. The rack and pinion steering system as claimed in claim 12, wherein the recess is of semicircular or V-shaped design.

14. The rack and pinion steering system as claimed in claim 1, wherein the guide roller is comprised of two parts.

15. The rack and pinion steering system as claimed in claim 1, wherein the guide roller and the supporting spindle are designed in one piece with each other.
